(19) United States
(12) Patent Application Publication
(10) Pub. No.: US 2023/0010131 A1
(43) Pub. Date: Jan. 12, 2023

(54) SULFUR CATHODE

(71) Applicant: UTI LIMITED PARTNERSHIP, Calgary (CA)

(72) Inventors: VENKATARAMAN THANGADURAI, Calgary (CA); AKHIL MAMMOOTTIL ABRAHAM, Calgary (CA); SATHISH PONNURANGAM, Calgary (CA)

(73) Assignee: UTI LIMITED PARTNERSHIP, Calgary, AB (CA)

(21) Appl. No.: 17/780,395

(22) PCT Filed: Nov. 20, 2020
(86) PCT No.: PCT/CA2020/051587

§ 371 Date: May 26, 2022

Related U.S. Application Data
(60) Provisional application No. 62/940,641, filed on Nov. 26, 2019.

(51) Int. Cl. H01M 4/58; H01M 10/052; H01M 4/04; H01M 4/62

(52) U.S. Cl. CPC H01M 4/5815; H01M 10/052; H01M 4/0471; H01M 4/044; H01M 4/625; H01M 2004/028

(57) ABSTRACT

A sulfur cathode generated at least in part by in situ electrochemical pulverization of a metallic sulfide compound is provided. The in situ generated sulfur cathode suppresses the unfavorable process of polysulfide shuttling to provide enhanced sulfur cathode performance and is envisioned for use in Li—S, Na—S, K—S, Ca—S, Mg—S or Al—S batteries used to support rechargeable electronic devices and electric vehicles.

### FIELD OF THE INVENTION

The present disclosure relates to batteries and in particular to batteries having sulfur cathodes, such as Li—S, Na—S, K—S, Ca—S, Mg—S or Al—S batteries.

### BACKGROUND

Electric vehicles require efficient, low-cost, and safe energy storage systems with high energy density and high power capability.¹ Lithium ion batteries can be used as a power source in many applications ranging from vehicles to portable electronics such as laptop computers, cellular phones and other electronic devices.² The electric vehicles powered by conventional lithium-cobalt or lithium-iron phosphate batteries often have a driving range of less than 160 km per charge.

A battery based on Li—S electrochemistry would offer an attractive technology that meets requirements for low cost and high specific density.³ Li—S battery technology has been the subject of intense research and development both in academia and in industry due to its high theoretical specific energy of 2600 Wh/kg as well as the low cost of sulfur.⁴ The theoretical capacity of sulfur via two-electron reduction (S+2Li⁺+2e⁻⇄Li₂S), is 1672 mAh/g (elemental sulfur is reduced to S²⁻ anion).⁵ The discharge process starts from a crown S₈ molecule and proceeds through reduction to higher-order polysulfide anions (Li₂S₈, Li₂Se) at a high voltage plateau (2.3-2.4 V), followed by further reduction to lower-order polysulfides (Li₂S₄, Li₂S₂) at a low voltage plateau (2.1 V), terminating with the Li₂S product.⁶ During the charge process, Li₂S is oxidized back to S₈ through the intermediate polysulfide anions Sₓ. The Sₓ polysulfides generated at the cathode are soluble in the electrolyte and can migrate to the anode where they react with the lithium electrode in a parasitic fashion to generate lower-order polysulfides, which diffuse back to the cathode and regenerate the higher forms of polysulfide. This shuttle effect leads to decreased sulfur utilization, self-discharge, poor ability to repeatedly cycle through oxidation and reduction, and reduced Coulombic efficiency of the battery.⁷ The insulating nature of S and Li₂S results in poor electrode rechargeability and limited rate capability. In addition, an 80% volume expansion takes place during discharge.¹³ These factors have precluded the commercialization of Li—S batteries in electric vehicles.

To circumvent these obstacles, extensive efforts have been devoted to improvement of sulfur cathodes. Such efforts have included providing conditions for infiltration or in situ growth of sulfur into or onto conductive scaffolds, such as conductive polymers (e.g., polythiophene, polypyrrole, and polyaniline) and porous carbons (e.g., active carbons, mesoporous carbons, hollow carbon spheres, carbon fibers, and graphene).^{3,8} It has been generally found that incorporation of sulfur within conductive polymers results in sulfur/polymer cathodes with improved capacity and cycling stability. The sulfur and the polymer may be crosslinked, leading to electrodes with further improved cycling life.⁷ Compared with polymeric scaffolds, carbon scaffolds offer many advantages, such as enhanced stability and conductivity, low cost, and controllable pore structure, which make them more attractive candidates for sulfur cathodes. Polymers (e.g., poly(ethylene oxide) and poly(3,4-ethylenedioxythiophene)-poly(styrene sulfonate)) may be coated on the carbon/sulfur composites to further improve their cycling life and Coulombic efficiency. However, current sulfur cathodes have not proven satisfactory for development of high-performance Li—S batteries. Current sulfur cathodes do not sufficiently retard polysulfide migration to a sufficient extent to prolong cathode cycling life. During discharge of current sulfur/carbon cathodes, the cyclic S₈ molecules are converted to polysulfides (Li₂Sₙ, 2<n<8) that are smaller than the S₈ molecules. Driven by the concentration gradient, the polysulfides unavoidably diffuse away from the cathodes, causing rapid loss of capacity and resulting in poor cycling.

Efforts to improve Li—S batteries are described, for example, in European Patent EP3170216 and U.S. Patent Publication No. US20180079865, each incorporated herein by reference in entirety.

There continues to be a need for improvements in cathodes for batteries such as Na—S, K—S, Ca—S, Mg—S or Al—S batteries.

### SUMMARY

The present technology provides sulfur cathodes and batteries including sulfur cathodes. In some embodiments, the sulfur cathodes are completely generated in situ or are based on existing cathodes with sulfur added. The added sulfur may be generated in situ using processes described herein.

In one example embodiment, generation of a sulfur cathode is provided in situ (i-SC) via electrochemical pulverization of tungsten trisulfide (WS₃). Bridging or apical disulphide ligand (S₂²⁻) in WS₃ forms lithium sulphide at ˜1.9 V vs Li/Li⁺ during the first lithiation cycle. The subsequent electrochemical delithiation/lithiation allows the formation of thermodynamically favorable products at higher voltages, preferably above 2.4 V vs Li/Li⁺. This facilitates a pseudo lithium-sulfur reaction mechanism in a long term cycle with higher order and lower order polysulphide displaying voltage plateaus at 2.39 V vs Li/Li⁺ and 2.12-2.2 V vs Li/Li⁺, respectively. WS₂ formed in the preliminary cycle encourages surface adsorption of Li₂Sₓ, suppressing polysulphide shuttling and negligible over-potential for catalytic oxidation of latter. Electrochemical performance of i-SC provides a remarkable initial discharge capacity of ˜ 1300 mAh/g and a reversible capacity of ˜ 1200 mAh/g is obtained in subsequent cycles at 0.5 C. An excellent discharge capacity of 850 mAh/g and 400 mAh/g was demonstrated by i-SC when cycled at rate of 1.5 C and 2 C, respectively, for 150 cycles with a columbic efficiency of 99.8%.

In accordance with one aspect of the technology, there is provided a Li—S, Na—S, K—S, Ca—S, Mg—S or Al—S battery which includes a cathode generated at least in part by electrochemical pulverization of a metallic sulfide compound. The electrochemical pulverization of the metallic sulfide may be provided in situ during an electrochemical process.

The metallic sulfide compound is a tungsten sulfide compound. The tungsten sulfide compound may be WS₃.

In some embodiments, the battery is a Li—S battery and the electrochemical pulverization generates WS₂ and Li₂S as active electrochemical species.

In some embodiments, the electrochemical pulverization occurs at about 1.9 V vs. Li/Li⁺.

The WS₃ may be amorphous and/or crystalline WS₃ prepared in a process including milling of (NH₄)₂WS₄, followed by annealing. The annealing may be conducted at a temperature between about 190° C. to about 330° C.

In some embodiments, the milling is performed in the presence of graphene nanoplatelets, carbon sulfides, metal sulfides or metal oxides.

In some embodiments, the Li₂S is converted to Li⁺ and Sₓ at about 2.4 V vs. Li/Li⁺.

In some embodiments, the Sₓ and the Li⁺ are converted to Li₂Sₓ=_{4,6,8} at about 2.4 V vs. Li/Li⁺.

In some embodiments, Li₂Sₓ=_{4,6,3} is converted to Li₂S at about 2.1 V vs. Li/Li⁺.

In some embodiments, the WS₂ is generated in the form of sheets ranging in length between about 20 nm to about 1500 nm.

In some embodiments, the electrochemical pulverization occurs continuously during electrochemical cycles.

Another aspect of the technology is a battery comprising a cathode including WS₂ in the form of sheets ranging in length between about 20 nm to about 1500 nm.

In some embodiments, the WS₂ is generated in situ by electrochemical pulverization of WS₃.

In some embodiments, the WS₃ is prepared in a process including milling of (NH₄)₂WS₄, followed by annealing. The annealing may be conducted at a temperature between about 190° C. and about 330° C. The milling may be performed in the presence of graphene nanoplatelets to provide a nucleation surface.

In some embodiments, the electrochemical pulverization occurs continuously during electrochemical cycles.

Another aspect of the technology is a sulfur cathode generated at least in part by electrochemical pulverization of a metallic sulfide compound in situ during an electrochemical process. The metallic sulfide compound may be a tungsten sulfide compound. The tungsten sulfide compound may be WS₃.

In some embodiments, the electrochemical pulverization generates WS₂ and Li2ₛ as active electrochemical species.

Another aspect of the technology is a Li—S battery comprising the sulfur cathode as described herein.

### BRIEF DESCRIPTION OF THE DRAWINGS

Various objects, features and advantages of the invention will be apparent from the following description of particular embodiments of the invention as supported by the drawings.

FIG. 1 is a schematic illustration of synthesis of tungsten trisulfide (WS₃) via an all-solid-state soft synthesis approach.

FIG. 2 includes an SEM image of amorphous WS₃ showing granule-like morphology (left) and images of elemental mapping of the WS₃ surface confirming uniform distribution of tungsten (right upper panel) and sulfur (right lower panel).

FIG. 3 is an SEM image (cross-section) of the cathode before discharge with a thickness of ˜25 μm (tungsten trisulfide loading ˜3 mg/cm²) (left side) and images of mapping of the cross section validating presence of tungsten, sulfur and carbon support (right side).

FIG. 4a is an image of the surface morphology of WS₃ at 30,000× magnification.

FIG. 4b is an image of the surface morphology of WS₃ at 100,000× magnification.

FIG. 5 is a thermal gravimetric plot obtained for (NH₄)₂WS₄ indicating the reaction pathway for formation of amorphous WS₃.

FIG. 6 is a schematic representation of generation of the in situ sulfur cathode produced by electrochemical pulverization followed by pseudo lithium-sulfur electrochemistry to provide stable battery performance.

FIG. 7a is an SEM image of the in situ cathode produced as illustrated in FIG. 2a obtained at 30,000× magnification after an initial cycle.

FIG. 7b is an SEM image of the in situ cathode produced as illustrated in FIG. 2a obtained at 100,000× magnification after an initial cycle.

FIG. 7c is an SEM image of the in situ cathode produced as illustrated in FIG. 2a obtained at 200,000× magnification after an initial cycle.

FIG. 7d is an elemental mapping image of the in situ cathode showing distribution of tungsten and sulfur after the initial discharge.

FIG. 8 shows XRD patterns of the in situ cathode obtained for a cell before initial discharge and for cells disassembled after the 1 stand 150th cycles. Evolution of WS₂ nanostructure is associated with peaks labelled (002) and (004) and peaks labelled (111), (220) and (311) are attributed to Li₂S.

FIG. 9a is an EDX spectrum of the in situ cathode obtained after the 1^{st} cycle.

FIG. 9b is an EDX spectrum of the in situ cathode obtained after the 100^{th} cycle.

FIG. 9c is an EDX spectrum of the in situ cathode obtained after the 150^{th} cycle.

FIG. 10a is a cyclic voltammetry plot obtained demonstrating the formation of the in situ cathode in an initial reduction reaction at ˜1.9 V followed by reversible performance of the electrochemically generated in situ cathode for over four cycles.

FIG. 10b is a plot showing a series of charge/discharge curves obtained for the stable in situ cathode for first five cycles at 0.5 C.

FIG. 10c is a plot showing specific capacity values obtained for varying current rate (0.5 C to 2 C) demonstrating the effective charge/discharge capability of the in situ cathode.

FIG. 10d is a plot showing a series of charge/discharge curves obtained at different temperatures with reduced overpotential for catalytic activity of the in situ formed WS₂ nanosheets.

FIG. 10e is a plot showing the rate capability of the in situ-generated cathode over prolonged cycles at 1.5 C and 2 C, with Coulombic efficiency of ˜99.8%.

FIG. 11a is a S 2p XPS spectrum of the in situ sulfur cathode before discharge.

FIG. 11b is an S 2p XPS spectrum of the in situ sulfur cathode after discharge.

FIG. 12a is a TEM image of the cathode before discharge.

FIG. 12b is a TEM image of the cathode after discharge.

FIG. 13a is a plot of open circuit voltage (OCV) of in situ sulfur cathode before discharge after several days and on the right initial discharge hour at an applied current load of 800 mA g⁻¹.

FIG. 13b is a plot of initial specific discharge capacity of in situ sulfur cathode rested after several days.

### DETAILED DESCRIPTION

Introduction and Rationale

The key issue which has prevented wide-scale development of Li—S batteries is the polysulfide shuttle effect that is responsible for the progressive leakage of active material from the cathode resulting in low life cycle of the battery. Moreover, the extremely low electrical conductivity of sulfur cathode requires an extra mass for a conducting agent in order to exploit the whole contribution of active mass to the capacity. The present inventors have recognized that the polysulfide shuttle effect could be mitigated using tungsten trisulfide as cathode precursor material.

Described herein is a process for in situ generation of a sulfur cathode via electrochemical pulverization of tungsten trisulfide (WS₃). The general term “electrochemical pulverization” is defined herein as a process of breaking a particle into smaller particles as a result of an electrochemical process. In one example of electrochemical pulverization described herein, the bridging or apical disulfide ligand (S₂²⁻) of WS₃ forms lithium sulfide at ˜ 1.9 V vs Li/Li⁺ during the first lithiation cycle. The subsequent electrochemical delithiation/lithiation allows the formation of thermodynamically favorable higher order polysulfide or sulfur at higher voltages, preferably above 2.4 V vs Li/Li⁺. This facilitates the pseudo lithium-sulfur reaction mechanism in a long term cycle with higher order and lower order polysulfides displaying voltage plateaus at 2.39 V vs Li/Li⁺ and 2.12-2.2 V vs Li/Li⁺, respectively. WS₂, which is formed in the preliminary cycle, promotes surface adsorption of Li₂S_{4<x<8}. This suppresses polysulfide shuttling and minimum over-potential for catalytic oxidation of polysulfides. Electrochemical performance of the in situ generated sulfur cathode is favorable with an initial discharge capacity of ˜ 1300 mAh/g and a reversible capacity of ˜1200 mAh/g obtained in following cycles at 0.5 C. An excellent discharge capacity of 850 mAh/g and 400 mAh/g was demonstrated by the system when cycled at rate of 1.5 C and 2 C, respectively, for 150 cycles with a Coulombic efficiency of 99.8%.

While the example embodiment described below is focused on generating an in situ cathode using a tungsten-based sulfur compound for lithium batteries, the strategy employed is expected to be applicable to other metal batteries such as sodium, potassium, aluminum, calcium and magnesium.

Synthesis and Characterization of the WS₃ for the In Situ Cathode

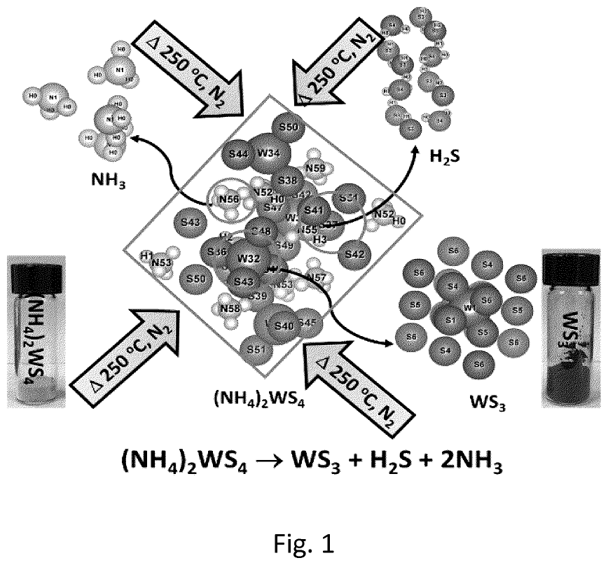

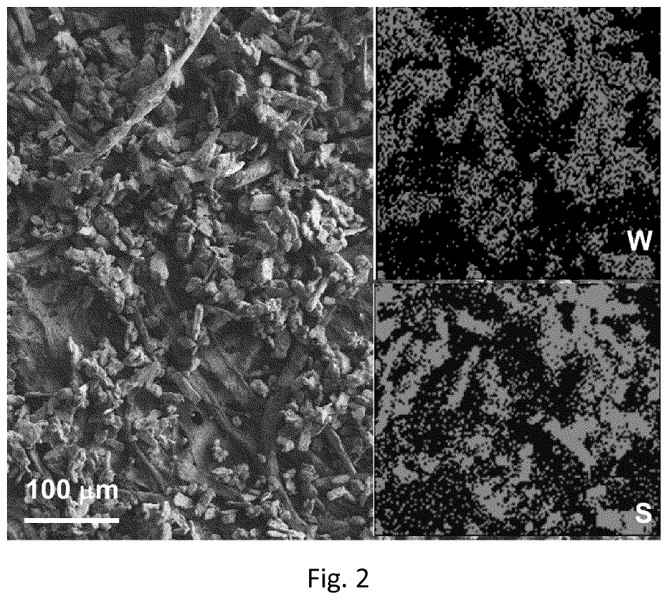

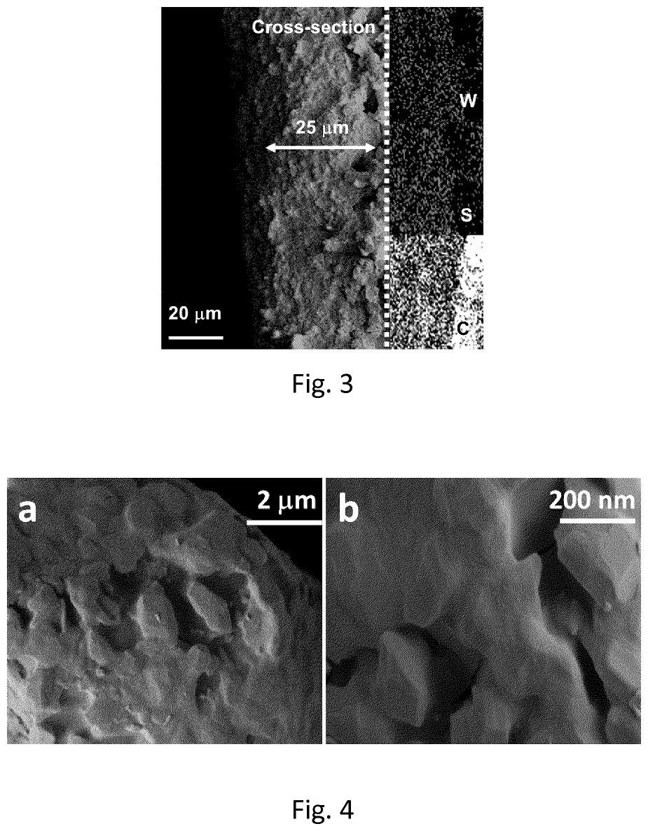

WS₃ was prepared using an all-solid-state soft synthesis approach reported elsewhere which is illustrated schematically in FIG. 1.^{9,10} In a typical synthesis, 0.45 g of precursor ammonium tetrathiotungstate, (NH₄)₂WS₄, was roll-milled with 0.05 g of graphene nanoplatelets in a 20 mL sample vial containing 5 mm diameter zirconium balls for 12 hours. The composite was annealed at 250° C. under an N₂ atmosphere, resulting in a structurally stable amorphous mass of WS₃ following the decomposition pathway (NH₄)₂WS₄→WS₃+H₂S+NH₃. It was found that 10% (m/m) of graphene provides an excellent nucleation surface for growth of WS₃ microstructure. The annealed product (250° C.) was used to prepare the cathode. FIG. 2 displays the scanning electron microscopy (SEM) image of produced WS₃. A granule like morphology was observed, indicating the amorphous nature of WS₃. Elemental mapping performed over the surface shows a uniform distribution of tungsten and elemental sulfur (FIG. 2, inset). A relatively thick cathode was prepared to ensure improved sulfur loading. FIG. 3 shows the cross-section (SEM) of fabricated dense cathode with a thickness of ˜ 25 μm. Tungsten trisulfide loading estimated over the coating area of ˜ 0.5 cm² was 3 mg/cm². Elemental mapping conducted over the cross-section confirms uniform distribution of tungsten and sulfur on a carbon current collector (FIG. 3, inset).

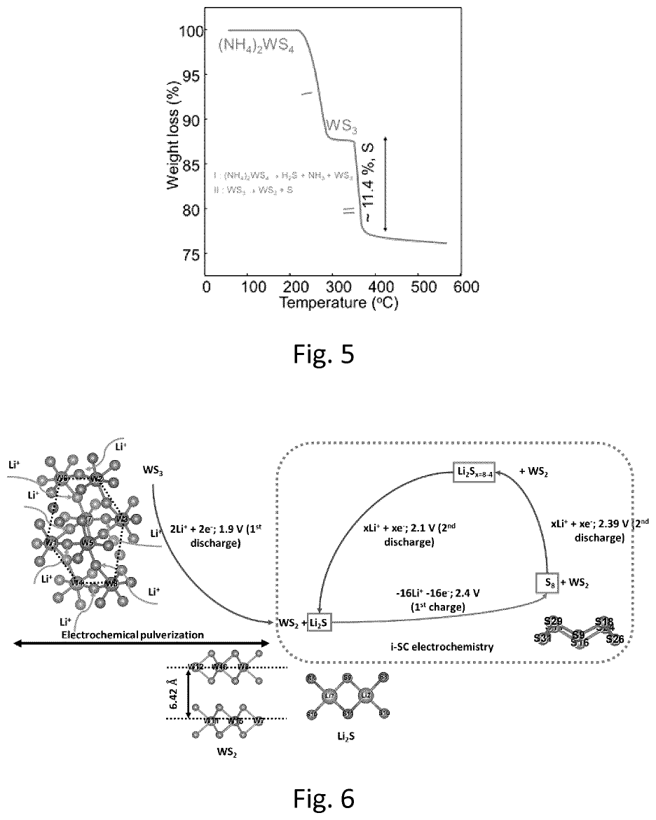

Additionally, high magnification SEM images of WS₃ topology were collected to confirm the coarse surface of produced WS₃ (FIGS. 4a and b). Thermal gravimetric analysis (TGA) demonstrating the formation of thermally stable amorphous WS₃ via the aforementioned reaction pathway and percentage sulfur content is shown in FIG. 5. An initial weight loss of about 13% (m/m) at ˜ 200° C. is associated with production of H₂S+NH₃, and thermally stable WS₃ is observed in the temperature range between about 250° C. -325° C. under the conditions employed. This range may be extended under other conditions to cover about 220° C. to about 325° C.

Electrochemical Generation of the In Situ Sulfur Cathode

A schematic reaction process for generation of the in situ sulfur cathode via electrochemical pulverization of WS₃ is shown in FIG. 6. The WS₃ precursor is arranged in a lattice forming WS₆ polyhedra. At 1.9 V vs. Li/Li⁺, the bridging disulfide ligand in WS₆ polyhedra generates a discharge product Li₂S in the initial discharge cycle accompanied by generation of WS₂ that can electrochemically catalyze polysulfides. With reversal of polarity (delithiation), the discharge product Li₂S is converted to the higher order polysulfide Li₂S₈ or polymeric S₈ at ˜>2.3 V vs Li/Li⁺ on the electrochemically active WS₂ surface.

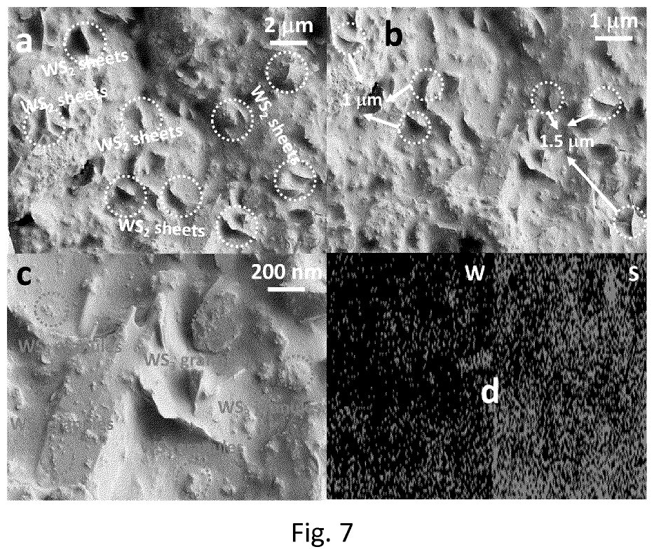

FIGS. 7a-c are SEM images of the in situ-generated cathode after initial discharge at 20,000×, 50,000× and 100,000× magnifications respectively. The granule-like morphology associated with WS₃ observed is initially transformed to a layered microstructure with dimensions ranging from 1000 nm-1500 nm which are typical of crystalline WS₂. Elemental mapping conducted over the evolved microstructure confirmed uniform distribution of tungsten and sulfur (FIG. 7d).

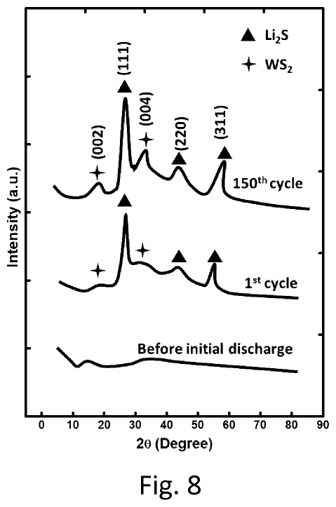

FIG. 8 shows a series of X-ray diffraction (XRD) patterns indicating evolution of the cathode morphology after several electrochemical cycles. Cells were disassembled after the 1st and 150th discharge cycle. It can be seen in FIG. 3a that the XRD pattern is featureless prior to the first cycle. This indicates the amorphous nature of the WS₃ precursor material. After the 1st discharge cycle, diffraction peaks observed at 2θ=26° and 52°, labelled (111) and (311) respectively, are associated with formation of Li₂S. The characteristic peaks attributed to WS₂, were observed at 2θ=14° and 30° respectively. Diffraction peaks obtained ex situ at the 150^{th} cycle exhibit dominant presence of Li₂S signals (2θ=26° and 52°)¹¹ and WS₂ signals (2θ=14° and 30°),¹² confirming generation of the electrochemically active WS₂ catalyst via in situ electrochemical pulverization of amorphous WS₃.

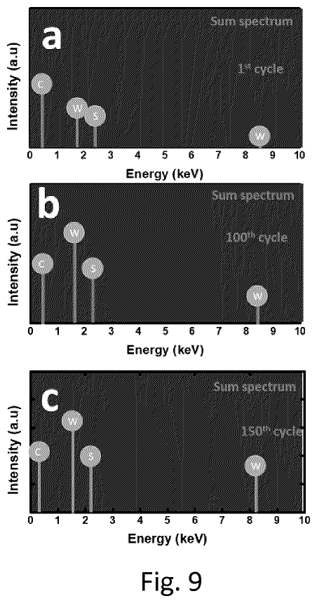

FIGS. 9a-c are energy dispersive x-ray (EDX) spectra obtained for cells discharged after the 1^{st} cycle, the 100^{th} cycle and the 150th cycle, respectively. The La and Kα peaks associated with tungsten and sulfur at 1.8 keV and 2.3 keV respectively, suggest formation of WS₂ microstructure after the initial discharge. Eventual appearance of the Kα peak at 8.2 keV observed after the 100th cycle and the 150th cycle indicates breakdown of the layered WS₂ structural geometry to elemental tungsten (W). The sheet length of the WS₂ nanostructure ranges between about 20 nm to about 1500 nm after the 150th cycle. This is believed to be caused by continued electrochemical pulverization occurring in the cycling window.

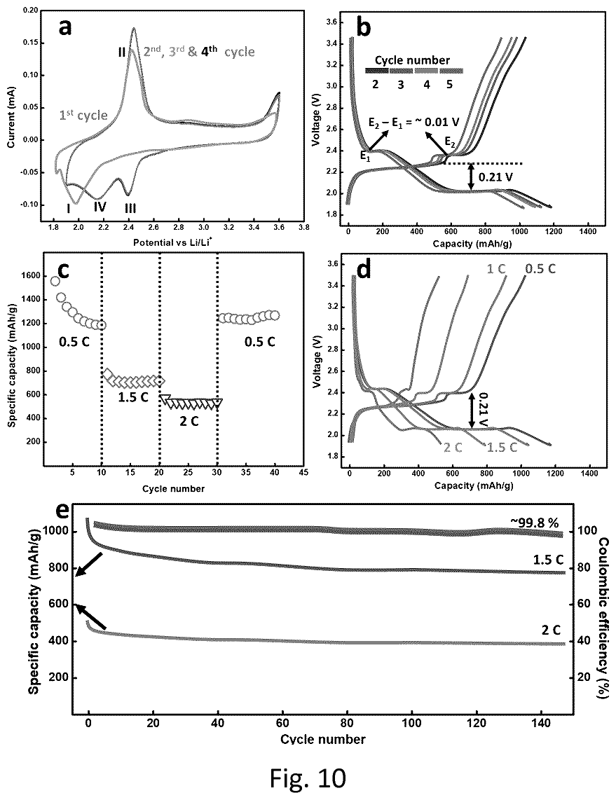

FIG. 10a shows a cyclic voltammetry (CV) plot exhibiting electrochemical generation of the in situ cathode. The bridging disulfide ligand (S₂²⁻) of WS₃ forms the final discharge product Li₂S in the initial reduction cycle (1.9 V vs Li/Li⁺). Within the subsequent cycling window, formation of thermodynamically favored S₈ occurs >2.4 V vs. Li/Li⁺(oxidation), and formation of a combination of Li₂S₈, Li₂S₆, and Li₂S₄ occurs at 2.39 V vs. Li/Li⁺(reduction). Reduction of these species to Li₂S occurs at 2.1 V vs. Li/Li⁺. The complete set of electrochemical reactions occurring in the CV plot of FIG. 4a is provided below.

WS₃+Li⁺+e⁻→Li₂S+WS₂1.9 V I

8Li₂S→16Li⁺+16e⁻+S₈>2.4 V II

S₈+xLi⁺+xe^{-→Li}₂S_{x=4,6,3}2.39 V III

Li₂S_{x=4,6,8}+xLi⁺+xe^{-→Li}₂S2.1 V IV

To ensure complete stripping of Li⁺ ions, the final charging voltage was capped at ˜3.5 V vs Li/Li⁺, where electrolyte decomposition is initiated (FIG. 10a). However, allowing further lithiation past a reduction potential of Li₂S at ˜1.9 V vs Li/Li⁺ results in Li⁺/WS₂ insertion chemistry at ˜ 1.25 V vs Li/Li⁺(LiₓWS₂), followed by irreversible breakdown of WS₂ sheets into tungsten metal (W) at <0.75 V vs Li/Li⁺ thus limiting the sulfur reaction chemistry observed in the range between 2.1 V and 2.4 V vs Li/Li⁺. In order to circumvent this issue, the cycling window was restricted to 1.9 V-3.5 V vs Li/Li⁺ to access only Li—S conversion chemistry for stable cell performance.

FIG. 10b demonstrates the charge/discharge curve of the in situ cathode for the first five cycles. An initial discharge capacity of ˜ 1200 mAh/g and a reversible capacity of ˜ 1100 mAh/g were determined at 0.5 C. A plot of specific capacity vs. cycle number for the in situ cathode in the current load range of 0.5 C-2 C is provided in FIG. 10c. An excellent capacity (˜1550 mAh/g) close to theoretical capacity of elemental sulfur (1675 mAh/g) was obtained at 0.5 C. A high capacity of ˜ 600 mAh/g was obtained when cycled at 2 C. This can be attributed to strong catalytic activity of in situ-formed WS₂ nanosheets. The significant observation that the overpotential for oxidation of polysulfide was reduced to 0.21 V can be attributed to surface catalytic activity of the layered WS₂ nanostructure (FIG. 10d). Furthermore, the assembled cell was subjected to charge/discharge over 150 cycles at 1.5 C and 2 C respectively. The in situ cathode retained a specific capacity of 950 mAh/g and 500 mAh/g at 1.5 C and 2 C respectively with Coulombic efficiency of ˜99.8% even after a prolonged charge/discharge cycle (FIG. 10e).

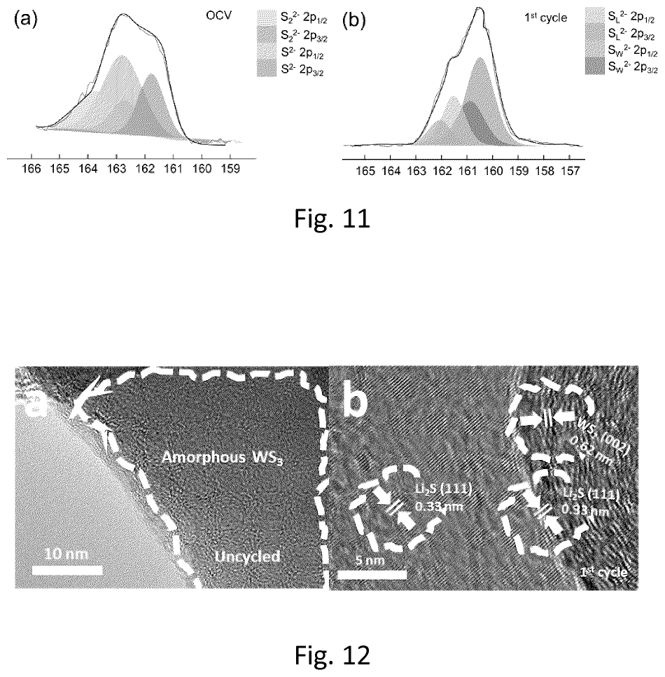

The deconvoluted high resolution X-ray photoelectron spectroscopy (XPS) spectra of S 2p show two peaks at 161.80 eV and 162.96 eV respectively, pertaining to S 2p_{1/2} and S 2p_{3/2} of apical S²⁻ ligands in WS₃. Similarly, peaks observed at 162.80 eV and 163.96 eV respectively, can be attributed to S 2p_{1/2} and S 2p_{3/2} of bridging S₂²⁻ ligands in WS₃ (FIG. 11a). FIG. 11b display the chemical state of sulfur species in in situ cathode after 1^{st} discharge cycle. The presence of peaks designated at 160.90 eV and 162.06 eV attributed to S_{w}²⁻ 2p_{1/2} and S_{w}²⁻2p_{3/2} affirms the electrochemical pulverization of WS₃ into WS₂ after initial discharge. Additionally, S 2p spectrum also consist of S 2p_{1/2} and S 2p_{3/2} signals originating from bridging sulfur atom (S_{L}) in Li₂S at 161.66 eV and 160.50 eV respectively. FIGS. 12a and 12b show transmission electron microscopy (TEM) images of the in situ sulfur cathode before and after discharge, respectively. A visible ordered pattern was not observed for the in situ sulfur cathode before discharge. This indicates the amorphous nature of WS₃, whereas the in situ sulfur cathode after discharge exhibits a layered geometry with a d spacing of ˜ 0.62 nm and 0.33 nm associated with crystalline WS₂ and Li₂S respectively.

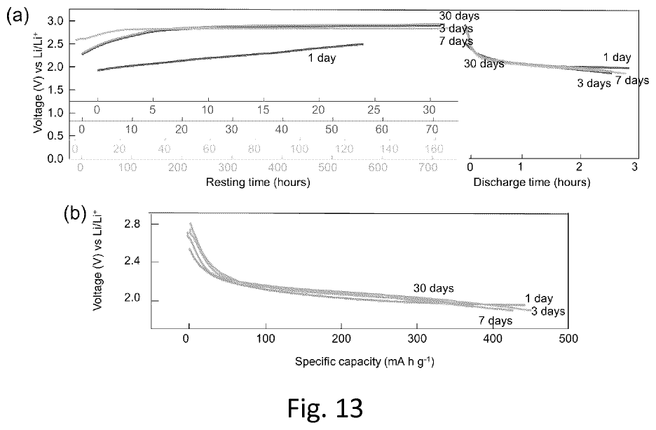

A battery that undergoes self-discharge is of no commercial importance regardless of its high gravimetric capacity. Here we demonstrate that the static electrochemical stability of WS₃ presents a remarkable shelf life. The FIG. 13a shows the voltage retention after 1, 3, 7 and 30 days. Very interestingly, no drop-in voltage was observed after several days of resting hours. The WS₃ electrode exhibited stable voltage plateau at 2.40, 2.80, 2.79 and 2.80 V after 1, 3, 7 and 30 days respectively. This can be attributed to electrochemical stability of S₂²⁻ ligands in WS₃. FIG. 13a, right panel demonstrates the initial discharge hours after 1, 3, 7 and 30 days. All the electrodes display a voltage plateau of 2 V pertaining to reduction of S₂²⁻ bridging disulfide ligands in a-WS₃. The initial specific discharge capacity for the latter is also provided in FIG. 13b.

Equivalents and Scope

Other than described herein, or unless otherwise expressly specified, all of the numerical ranges, amounts, values and percentages, such as those for amounts of materials, elemental contents, times and current rate, ratios of amounts, and others, in the following portion of the specification and attached claims may be read as if prefaced by the word “about” even though the term “about” may not expressly appear with the value, amount, or range. Accordingly, unless indicated to the contrary, the numerical parameters set forth in the following specification and attached claims are approximations that may vary depending upon the desired properties sought to be obtained. At the very least, and not as an attempt to limit the application of the doctrine of equivalents to the scope of the claims, each numerical parameter should at least be construed in light of the number of reported significant digits and by applying ordinary rounding techniques.

Any patent, publication, internet site, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

Unless otherwise defined, all technical and scientific terms used herein have the same meaning as commonly understood by one of ordinary skill in the art.

While the technology been particularly shown and described with references to embodiments thereof, it will be understood by those skilled in the art that various changes in form and details may be made therein without departing from the scope of the invention encompassed by the appended claims.

In the claims, articles such as “a,” “an,” and “the” may mean one or more than one unless indicated to the contrary or otherwise evident from the context. Claims or descriptions that include “or” between one or more members of a group are considered satisfied if one, more than one, or all of the group members are present in, employed in, or otherwise relevant to a given product or process unless indicated to the contrary or otherwise evident from the context.

It is also noted that the term “comprising” is intended to be open and permits but does not require the inclusion of additional elements or steps. When the term “comprising” is used herein, the term “consisting of” is thus also encompassed and disclosed. Where ranges are given, endpoints are included. Furthermore, it is to be understood that unless otherwise indicated or otherwise evident from the context and understanding of one of ordinary skill in the art, values that are expressed as ranges can assume any specific value or subrange within the stated ranges in different embodiments of the invention, to the tenth of the unit of the lower limit of the range, unless the context clearly dictates otherwise. Where the term “about” is used, it is understood to reflect+/−10% of the recited value. In addition, it is to be understood that any particular embodiment of the present invention that falls within the prior art may be explicitly excluded from any one or more of the claims. Since such embodiments are deemed to be known to one of ordinary skill in the art, they may be excluded even if the exclusion is not set forth explicitly herein.

### REFERENCES

1. Manthiram, A., Fu, Y., Chung, S. H., Zu, C. & Su, Y. S. Rechargeable lithium-sulfur batteries. Chemical Reviews 114, 11751-11787 (2014).
2. Manthiram, A., Fu, Y. & Su, Y. S. Challenges and prospects of lithium-sulfur batteries. Acc. Chem. Res. 46, 1125-1134 (2013).
3. Pang, Q., Liang, X., Kwok, C. Y. & Nazar, L. F. Advances in lithium-sulfur batteries based on multifunctional cathodes and electrolytes. Nature Energy 1, 1-11 (2016).
4. Ji, X., Lee, K. T. & Nazar, L. F. A highly ordered nanostructured carbon-sulphur cathode for lithium-sulphur batteries. Nat. Mater. 8, 500-506 (2009).
5. Wild, M. et al. Lithium sulfur batteries, a mechanistic review. Energy and Environmental Science 8, 3477-3494 (2015).
6. He, J. et al. Freestanding 1T MoS₂/graphene heterostructures as a highly efficient electrocatalyst for lithium polysulfides in Li—S batteries. Energy Environ. Sci. 12, 344-350 (2019).
7. Liu, T. et al. 12 years roadmap of the sulfur cathode for lithium sulfur batteries (2009-2020). Energy Storage Materials 30, 346-366 (2020).
8. Evers, S. & Nazar, L. F. Graphene-enveloped sulfur in a one pot reaction: A cathode with good coulombic efficiency and high practical sulfur content. Chem. Commun. 48, 1233-1235 (2012).
9. Lonkar, S. P., Pillai, V. V. & Alhassan, S. M. Three dimensional (3D) nanostructured assembly of MoS₂—WS₂/Graphene as high performance electrocatalysts. Int. J. Hydrogen Energy 45, 10475-10485 (2020).
10. Hunyadi, D., Vieira Machado Ramos, A. L. & Szilágyi, I. M. Thermal decomposition of ammonium tetrathiotungstate. J. Therm. Anal. Calorim. 120, 209-215 (2015).
11. Li, X. et al. A mechanochemical synthesis of submicron-sized Li₂S and a mesoporous Li₂S/C hybrid for high performance lithium/sulfur battery cathodes. J. Mater. Chem. A 5, 6471-6482 (2017).
12. Huang, Z., et al. Tungsten sulfide enhancing solar-driven hydrogen production from silicon nanowires. ACS Appl. Mater. Interfaces 6, 10408-10414 (2014).
13. Barai P., et al. Poromechanical effect in the lithium-sulfur battery cathode. Extreme Mechanics Lett. 9, 359-370 (2016).

What is claimed is:

1. A Li—S, Na—S, K—S, Ca—S, Mg—S or Al—S battery comprising a cathode generated by electrochemical pulverization of a metallic sulfide compound.

2. The battery of claim 1, wherein the electrochemical pulverization of the metallic sulfide is provided in situ during an electrochemical process.

3. The battery of claim 1, wherein the metallic sulfide compound is a tungsten sulfide compound.

4. The battery of claim 3, wherein the tungsten sulfide compound is WS₃.

5. The battery of claim 4, wherein the battery is a Li—S battery and the electrochemical pulverization generates WS₂ and Li₂S as active electrochemical species.

6. The battery of claim 4, wherein the electrochemical pulverization occurs at about 1.9 V vs. Li/Li⁺.

7. The battery of claim 3, wherein the WS₃ is amorphous and/or crystalline WS₃ prepared in a process including milling of (NH₄)₂WS₄, followed by annealing.

8. The battery of claim 7, wherein the annealing is conducted at a temperature between about 190° C. to about 330° C.

9. The battery of claim 7, wherein the milling is performed in the presence of graphene nanoplatelets, carbon sulfides, metal sulfides or metal oxides.

10. The battery of claim 4, wherein the Li₂S is converted to Li⁺ and Sₓ at about 2.4 V vs. Li/Li⁺.

11. The battery of claim 10, wherein the Sₓ and the Li⁺ are converted to Li₂S_{x=4,6,8} at about 2.4 V vs. Li/Li⁺.

12. The battery of claim 11, wherein the Li₂S_{x=4,6,8} is converted to Li₂S at about 2.1 V vs. Li/Li⁺.

13. The battery of claim 5, wherein the WS₂ is generated in the form of sheets ranging in length between about 20 nm to about 1500 nm.

14. The battery of claim 1, wherein the electrochemical pulverization occurs continuously during electrochemical cycles.

15. A battery comprising a cathode including WS₂ in the form of sheets ranging in length between about 20 nm to about 1500 nm.

16. The battery of claim 15, wherein the WS₂ is generated in situ by electrochemical pulverization of WS₃.

17. The battery of claim 16, wherein the WS₃ is prepared in a process including milling of (NH₄)₂WS₄, followed by annealing.

18. The battery of claim 17, wherein the annealing is conducted at a temperature between about 190° C. and about 330° C.

19. The battery of claim 17, wherein the milling is performed in the presence of graphene nanoplatelets to provide a nucleation surface.

20. The battery of claim 15, wherein the electrochemical pulverization occurs continuously during electrochemical cycles.

21. A sulfur cathode generated by electrochemical pulverization of a metallic sulfide compound in situ during an electrochemical process.

22. The sulfur cathode of claim 21, wherein the metallic sulfide compound is a tungsten sulfide compound.

23. The sulfur cathode of claim 22, wherein the tungsten sulfide compound is WS₃.

24. The sulfur cathode of claim 23, wherein the electrochemical pulverization generates WS₂ and Li₂S as active electrochemical species.

25. A Li—S battery comprising the sulfur cathode of claim 21.
